(19) United States
(12) Patent Application Publication
(10) Pub. No.: US 2006/0244832 A1
(43) Pub. Date: Nov. 2, 2006

(54) Device for recording a passenger of an amusement ride during the ride

(75) Inventor: Jens Scheberg, Dinslaken (DE)

Correspondence Address: BIRCH STEWART KOLASCH & BIRCH, PO BOX 747, FALLS CHURCH, VA, 22040-0747, US

(73) Assignee: DIVICOM GMBH

(21) Appl. No.: 11/200,079

(22) Filed: Aug. 10, 2005

(30) Foreign Application Priority Data
Apr. 14, 2005 (DE) DE 102005017353.5

(51) Int. Cl. H04N 7/18

(52) U.S. Cl. 348/159; 348/169

(57) ABSTRACT

A device and a method are provided with which a video recording of a passenger's ride on an amusement ride can be made, which the passenger can purchase after the end of the ride.

This nonprovisional application claims priority under 35 U.S.C. § 119(a) on German Patent Application No. DE 102005017353.5, which was filed in Germany on Apr. 14, 2005, and which is herein incorporated by reference.

### BACKGROUND OF THE INVENTION

1. Field of the Invention

The present invention relates to a video recording device for amusement rides and to a method for creating a video recording of the ride of a passenger on an amusement ride.

2. Description of the Background Art

Conventionally, photos are sold that show passengers on an amusement ride such as a roller coaster, a flume ride, or a white-water rafting ride. The photographic equipment used for this purpose is installed to be stationary and thus the photos only show snapshots from an external perspective.

### SUMMARY OF THE INVENTION

It is therefore an object of the present invention to provide a device and a method with which a video recording of a passenger's ride on an amusement ride can be made, which the passenger can purchase after the end of the ride.

A video recording device of the invention can have at least one camera aimed at a passenger during the ride, an on-board unit for processing and storing the recorded signals, a transmitting antenna, and an energy storage device, whereby the aforementioned components are placed on the passenger carrier, as well as a stationary receiving antenna and a stationary receiving unit. Furthermore, at least one microphone can be placed on the passenger carrier. In an advantageous manner, in so doing, a camera and at least one microphone are placed in a common housing. In this regard, the video signals are recorded with a camera and transmitted to a connected on-board unit. The audio signals are preferably recorded with at least one microphone and transmitted to the on-board unit. Digital data are created from the applied signals in this on-board unit, particularly in the form of an MPEG-2 stream. These digital data are transmitted by, for example, a transmitting unit and an antenna and received by, for example, a stationary antenna and receiving unit. The received data are then stored in a data storage unit. In an embodiment, at least one of the antennas is made as a directional antenna, because during simultaneous use of several on-board units on an amusement ride, all radio transmission devices can thus use the same frequency spectrum.

If the amusement ride is a roller coaster, for example, the period during which the passenger carrier, in this case a train or wagon, is at the station for loading and unloading is a possible time for the radio transmission of the digital data. In so doing, the passenger carrier is normally in a precisely defined position, for which reason it is then possible to place the transmitting and receiving antennas a short distance away and aimed precisely at one another. If the ride attraction is, for example, a white-water rafting ride, the radio transmission can occur during a slowly traversed section, for example, on a conveyer belt or in the station area. In this case, the transmitting antenna can be made omnidirectional. The receiving antenna can be a (trackable) directional antenna or also an omnidirectional antenna.

Instead of a normal recording solely in the visible light spectrum, (additionally) recording in the infrared region presents itself particularly for recording under poor light conditions or within buildings. With normal recording, an infrared filter is usually used, which works with the camera and filters out the infrared spectrum. The filter must therefore be inactivated during infrared recording. The filter is placed before the lens of the camera as needed and again removed, for example, by mechanical action. In a preferred alternative, normal and infrared cameras with the same or similar coverage area are used, with switching between them as needed, so that the digital data are produced from the output signal of the selected camera. Optionally, infrared light sources can be placed in the area of the passenger carrier, preferably in the area of the camera, which provide the necessary light intensity. In an advantageous manner, the light sources are operated only when the recording occurs in the infrared region. The recording occurs in the visible spectrum, in the infrared spectrum, or a combination of both.

In an embodiment of the invention, the cable for connecting an energy storage device to the on-board unit can have a special connecting plug, in which the address of the on-board unit can be encoded. To be able to differentiate several components, for example, on-board units, a unique address must be assigned to these. This can occur, for example, by DIP switches at the housing or by software. These options entail the risk, however, that the setting of the address is forgotten when an on-board unit is replaced and perhaps cannot be recognized. For this reason, the address is preferably encoded in the plug, which connects the on-board unit with the energy storage device. This can occur by a circuit being integrated into the plug and emitting an identification signal. The plug preferably has several pins or contact pins, as are necessary for the current supply, in whose wiring the address information is encoded in binary form.

The video recording device of the invention can have at least one other stationary data storage unit and/or at least one point of sale (POS) terminal and/or at least one display device. The data transmitted by radio are stored in the stationary data storage unit, as already indicated above. The data or excerpts of data can be presented on the display device, which is preferably a monitor. By means of the POS terminal, the passenger's wish to purchase his recording can be entered in the video recording device. In an advantageous embodiment of the invention, a limited presentation loop and/or a photo are produced from the digital data and shown to the passenger after the end of the ride. The presentation loop is an excerpt from the ride with a predefined length. The photo is a fixed image from the video recording. The presentation loop and/or the photo are produced in the on-board unit in the passenger carrier or in the stationary part of the video recording device, depending on the implementation also in separate processes in different parts of the video recording device.

The device preferably has at least one converter for producing a special data structure, particularly a DVD image, from the digital data. It is possible to include in this special data structure, in addition to the data recorded during the ride, also other information such as a presentation video of the amusement ride operating company, advertising, or other data. The special data structure can then be written on a portable data carrier, particularly a DVD. It is possible in this case that the photo produced from the digital data is imprinted on the portable data carrier. This results in further personalization of the sold data carrier.

In an advantageous embodiment, the video recording device has a central management for controlling the stationary components. The management system is used particularly for resource management after an order, therefore for the distribution of the data to converters and devices for writing on a portable data carrier.

Stationary components are understood to be those components or assemblies of the device, which are not placed on or in the mobile passenger carrier. These include in particular the stationary data storage unit, the POS terminal, display devices, converters, and devices for writing on portable data carriers. Depending on the nature of the amusement ride and its environment, the stationary components are placed essentially in non-moving areas of the amusement ride, for example, the station or the loading platform, or in separate buildings or parts of buildings, such as a sales shop. The stationary components are preferably distributed at several sites. The receiving antenna and the receiving unit can be placed, for example, in the vicinity of a resting position of the passenger carrier and the POS terminal, display devices, and devices for writing on the data carrier in the sales shop.

In another embodiment of the invention, the digital data, the presentation loop, and/or the photo are stored in an external storage medium, particularly for viewing, for retrieval, and/or for ordering by means of a Web browser. This makes it possible that the passenger can order the recording, for example, via the Internet, even a certain time period after the ride. External storage is also desirable from security aspects, for example, for documenting possible improper conduct of a passenger. Optionally another device is provided by which the passenger is given specific access data, which he uses for authentication during later retrieval of the data from the external storage medium. This assures that a passenger can always access only recordings on which he himself can be seen or which he is authorized to access.

Optionally, the video recording device can connect to a network of a mobile communication provider. By this means, the digital data or excerpts from the digital data, for example, the presentation loop, can be sent to mobile terminals, particularly as MMS (Multimedia Message Service) via a mobile communication network. Preferably, conversion to a video format, which is supported by the employed service, occurs in the video recording device before the transmission, the resolution of the video data being adjusted simultaneously as necessary. It is possible, alternatively or in addition, to send the fixed image and/or the aforementioned access data to the mobile terminal. In addition to a mobile communication provider, the transmission can also occur through another provider who allows the transmission of multimedia messages or files in a mobile communication network.

The video recording device preferably has at least one control unit on the passenger carrier for controlling at least one on-board unit. This control unit coordinates the on-board units of a passenger carrier. It issues, for example, the commands for starting the recording of the digital data, for starting the recording of the digital data for a predetermined period, for marking the beginning of the presentation loop, for ending the recording of the digital data, for transmission of the digital data, for turning the transmission unit on or off, or for switching between normal and infrared recording. For this purpose, the control unit has a means for evaluating signals, which are transmitted or read by the signal generators on the track. Thus, for example, in a roller coaster, the signal for starting the recording can be transmitted directly behind the station. A signal transmitter, by which the beginning of the presentation loop is marked, can be positioned at a different location. Locations on the ride where special ride patterns or a particularly steep descent occur are particularly good options for this.

During the recording of digital data for a specified period, the recording is started by an appropriate signal and stopped automatically after a certain time. This lends itself particularly to roller coasters with a block system, in which a train can enter a block section of the track only when this section is free. If this is not the case, the train is held for the necessary time period in a block brake between the sections. If this is not to be recorded, the recording is always started before a track section only for approximately the time the train requires at most to pass through this section. In the normal case, the train passes through and the recording runs continuously. If the train is stopped, the recording stops automatically after the elapse of the predetermined time period and continues as soon as the train starts up again and passes the next signal transmitter. The period can be set individually for each section or preferably the same for all sections.

A loop of a settable length can be stored temporarily and overwritten cyclically during the periods during which the recording is stopped. Thus, after the command to start the recording, the filming of this period can be added to the recording retrospectively. Thus, for example, this is an option in a roller coaster when the train stands at the station for loading and unloading. The command to start the recording typically is given only when the train has already begun moving. Thus, the period before the departure of the train can also be integrated into the recording through the temporary storage of the video loop, without the entire loading process being recorded.

Through the turning on or off of the transmitting unit, first of all, the energy consumption of the mobile part of the video recording device can be reduced and also the undesired transmission of data prevented. Thus, the transmitting unit is preferably turned on only for the period during which the passenger carrier is within a particular spatial area, for example, a roller coaster train in the station for loading and unloading.

The signal transmitters can be active signal transmitters, which provide a signal on their own, or passive signal transmitters, which are read by the control unit. The control unit is preferably made as a stand-alone unit in a separate housing, alternatively as a component of an on-board unit, which therefore has a master functionality and controls the other on-board units. Optionally, a control unit is integrated into each on-board unit and therefore no separate control unit is necessary.

According to a feature of the invention, the on-board unit has at least one encoder to produce digital data from the received video and/or audio signals. Thus, the output signals of cameras and/or microphones are converted to digital data, particularly with a standardized format. In an advantageous manner, these digital data are temporarily stored in the on-board unit on the passenger carrier. For this purpose, a data storage unit can be provided which can be a memory, for example, a flash memory. Such storage media have the advantage of possessing a high resistance to jolting and other mechanical effects, which predestines them particularly for use in moving amusement rides.

Further, the on-board unit can have a data processing unit. The data processing unit can control the saving of the digital data from the encoder in the data storage unit and/or the data transfer from the data storage unit to the transmitting unit. Moreover, it provides the encoder with the necessary parameters to generate the digital data, for example, the desired data rate, and brings about the start and end of the encoding.

The on-board unit preferably has at least one transmitting unit for transmitting the data. By means of the transmitting unit, the digital data to be transmitted are made ready for transmission, amplified, and emitted via the transmitting antenna. The on-board unit advantageously has in addition an AC line adapter, which prepares the voltage supplied by the energy storage device, for example, filters and produces the necessary operating voltage(s) for the on-board unit. In addition, the on-board unit can be turned off by the AC line adapter as soon as the voltage supplied by the energy storage device falls below a certain value, for example, for a certain period. Furthermore, a camera control unit for controlling the camera can be optionally provided in the on-board unit for controlling the camera. Thus, camera parameters, such as shutter, aperture, or white balance, can be adapted to the prevailing conditions. The camera control unit can also be integrated into the data processing unit or the camera and/or the camera housing. Microphone preamplifiers can be provided as needed in the on-board unit; these amplify the recorded audio signal before the generation of the digital data in the encoder.

The on-board unit, in addition, can have a local control unit, which manages the components of the on-board unit. The local control unit can receive and preprocess control signals from the aforementioned master control unit. By means of these control signals, the local control unit can initiate the starting of the recording, the transmission of the data, the turning on or off of the power supply for the transmitting unit for energy conservation, the switching between normal and infrared recording, or other functions. In an advantageous manner, the commands received from the master control unit are converted to a format, which, for example, is supported by the data processing unit and by the camera. Optionally the local control device possesses means to turn the transmitting unit supply voltage on or off.

Depending on the design of the passenger carrier, it is desirable to execute commands in different on-board units at different times. This applies, for example, to switching between normal and infrared recording on a roller coaster train, when, depending on the position in the train, the cameras enter and again leave a building at different times. The delay in the control signal necessary for this occurs either centrally in the control unit with adaptation for each on-board unit or individually in the local control units of each on-board unit.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a block diagram of the recording device according to an embodiment of the present invention; and

FIG. 2 is a block diagram of a further embodiment of the present invention.

### DETAILED DESCRIPTION

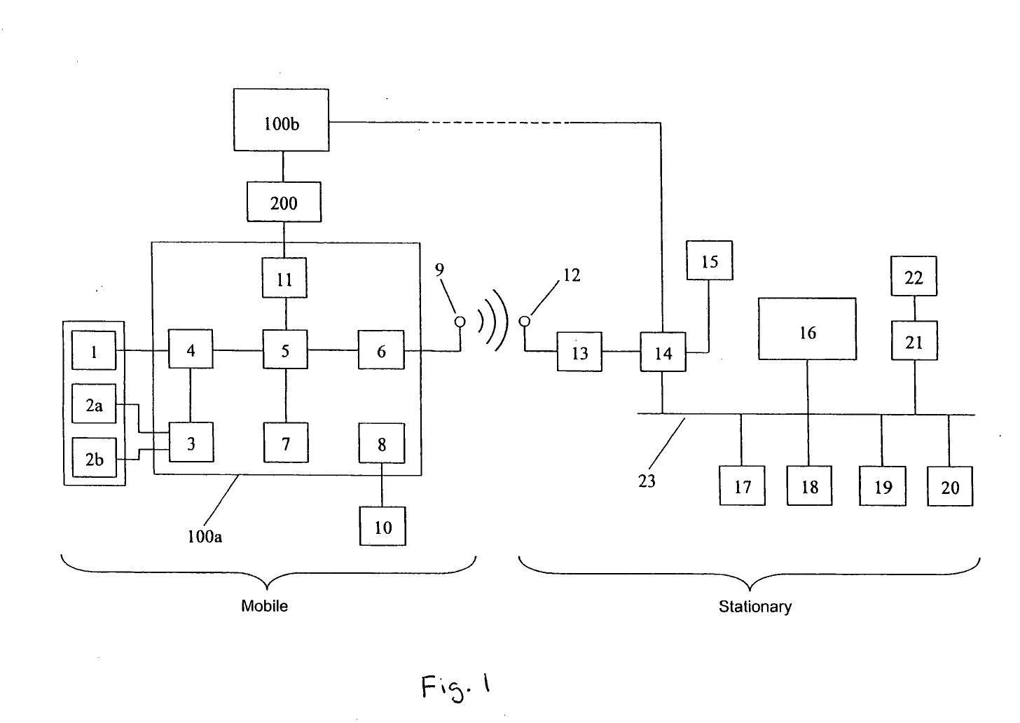

FIG. 1 shows schematically a video recording device of the invention, which includes a mobile and a stationary part. In this regard, the mobile part is placed on an amusement ride, particularly its passenger carriers. The stationary part can be located in a non-moving area of the amusement ride, in a shop, or distributed among the two. A rotating loading platform of a white-water rafting ride, for example, can also be regarded as the non-moving area.

In the present example, the camera 1 is mounted so that it records two passengers during the ride. Two microphones 2a and 2b are each focused on one of the passengers recorded by camera 1. Preferably, camera 1 and the two microphones 2a and 2b are located in a common housing. They are connected to a first on-board unit 100a by, for example, a cable. The video signal of camera 1 is fed substantially directly into an encoder 4. The audio signals of microphone 2a and 2b are first amplified in a microphone preamplifier 3 and then supplied to the encoder 4. The encoder 4 produces a digital AV data stream, preferably an MPEG-2 stream. This data stream is temporarily stored by a data processing unit 5 in a flash memory 7. When the passenger carrier reaches a certain position, for example, the train of a roller coaster is in the station, the recorded data stream is transmitted by a transmitting unit 6 and an antenna 9. The transmitting unit 6 is an access point, such as a UWB (Ultra Wide Band) access point or a wireless LAN access point.

The on-board unit 100a is powered by an energy storage device 10, preferably a battery. Preferably, each on-board unit is supplied by its own energy storage device. Alternatively, an energy storage device supplies all on-board units, which are perhaps placed on the passenger carrier, with energy, or in the particular case, only a few on-board units, for example, two. The on-board unit 100a further has an AC line adapter 8, which supplies components 3 to 7, as well as the camera 1 and microphone 2a and 2b, with energy via connecting lines not shown in the figure. The AC line adapter filters the voltage provided by the energy storage device 10 and produces the required supply voltages.

The on-board units 100a and 100b are controlled by a control unit 200. The control unit 200 in particular has means to receive and process signals emitted by signal transmitters placed along the ride track. Thus, it can be stipulated by means of the signal transmitter, for example, when the recording of the data stream is to begin or end. This information is provided by the control unit 200 to the connected on-board units 100a and 100b. In the present embodiment, the signal transmitters are each an arrangement of permanent magnets, whose magnetic field is detected by one or more sensors. The control signals are transmitted to the on-board units 100a and 100b depending on the detected magnetic field.

The control signals produced by control unit 200 are received by local control unit 11, which is placed in the on-board unit 100a, evaluated and executed or passed on to the appropriate components of the on-board unit 100a. Thus, the local control unit 11, for example, switches the current supply of the transmitting unit 6 or passes on the command for starting or stopping the recording to the data processing unit 5.

The signal emitted by the transmitting antenna 9 is received via a receiving antenna 12 of a receiving unit 13. The receiving unit 13 is a UWB or wireless LAN access point corresponding to transmitting unit 6. The received data are transmitted to a stationary data storage unit 14 and saved there. Preferably, the stationary data storage unit 14 stores the data of up to, for example, four on-board units. In the present example, for the sake of clarity, only connections to on-board units 100a and 100b are shown. In this regard, the connection between on-board unit 100b and data storage unit 14 is merely suggested. It also occurs via an antenna pair and a receiving unit as in the on-board unit 100a. The antennas 9 and 12 are preferably made as directional antennas, as a result of which the on-board units 100a and 100b can transmit at the same frequencies, without interfering with one another.

Preferably, a time limited presentation loop is already produced from the digital AV data stream in the on-board unit. This is transmitted to the stationary data storage unit 14 together with the AV data stream. This presentation loop is displayed on a monitor 15 so that the passenger can decide whether he would like to purchase the recording of his ride. The length of the presentation loop is freely adjustable and is preferably set once to a constant value. The time when the extraction of the presentation loop is to begin is determined by a signal transmitter on the ride track. If the data processing unit 5 receives the signal to create the presentation loop via the local control unit 11 from control unit 200, an appropriate label is saved. After the recording ends, a sequence of predefined length is extracted from the AV data and saved in the flash memory 7 for later transmission. In addition, a fixed image is created in the JPEG format later in the data storage unit 14.

Via a data bus 23, preferably an Ethernet network, the data storage unit 14 is linked to a management system 16, converters 17 and 18, DVD burners 19 and 20, and a POS terminal 21. From the video and possibly audio data of the passenger's ride, which are stored in the data storage unit 14, upon request the converters 17 and 18 create an ISO-conforming DVD image, which preferably contains additional ready-made data, for example, in form of a menu, video, or photo. Preferably, the data of the passenger's ride are inserted into a ready-made structure, which, for example, contains a prepared menu and/or video clip of the operating company of the amusement ride or an advertising partner. Alternatively, the menu is designed individually, for example, by insertion of the presentation loop.

Preferably, the ready-made data are available as VOB files (VOB: video OBject). VOB files are standardized files for use in a DVD, which can contain inter alia audio and video data. The data of the passenger's ride are converted in converter 17 or 18 also into one or more VOB file(s). Then, control information in the form of likewise standardized IFO and BUP files is generated and written together with the VOB files in an ISO image. The ISO image is therefore substantially made up of several individual components, as a result of which only a short time is needed for its creation.

Next, the ISO image is burned by one of the DVD burners 19 or 20 onto a DVD. Preferably, the fixed image created in the data storage unit 14 for further customization is printed on the DVD. The POS terminal 21 is used to handle the sale. It controls a monitor 22 to show once again the presentation loop or fixed image to the customer and to begin the creation of the DVD. The POS terminal 21 optionally has, in addition, a cash register functionality.

The control of the stationary components occurs by means of management system 16. It records the sale of a video and thereupon controls the data flow between the data storage unit 14, the converters 17 and 18, and the DVD burners 19 and 20.

It follows for the person skilled in the art that the present video recording device can be scaled as desired according to the requirements of the operating company of the amusement ride. Thus, with several passenger carriers on an amusement ride, for example, several trains of a roller coaster, one of the passenger carriers, several passenger carriers, or all passenger carriers can each have one or more on-board units (and correspondingly additional components such as cameras, microphones, or energy storage devices). Furthermore, any number of on-board units can be placed on the passenger carrier. The number of transmitting antennas varies with the number of on-board units. If the data are transmitted by radio relay, then the number of receiving antennas and receiving units typically corresponds to the number of transmitting antennas. At the same time, the number of stationary data storage units is variable. The number of converters and DVD burners and POS terminals can also be adjusted to the requirements of the operating company.

Although in the present example, one camera covers two passengers and one microphone is aimed at each passenger, a camera can also record only one passenger or a larger group of passengers. This also applies to the audio data by means of microphones. Several cameras can also be connected to one on-board unit.

For the radio transmission, in addition to the described techniques of UWB and wireless LAN, other types of transmission may also be used, which can provide the necessary bandwidth.

Of course, several of the components such as the encoder, microphone preamplifier, camera control unit, data processing unit, data storage unit, transmitting unit, and local control unit can be combined in a single component, for example, integrated on a card.

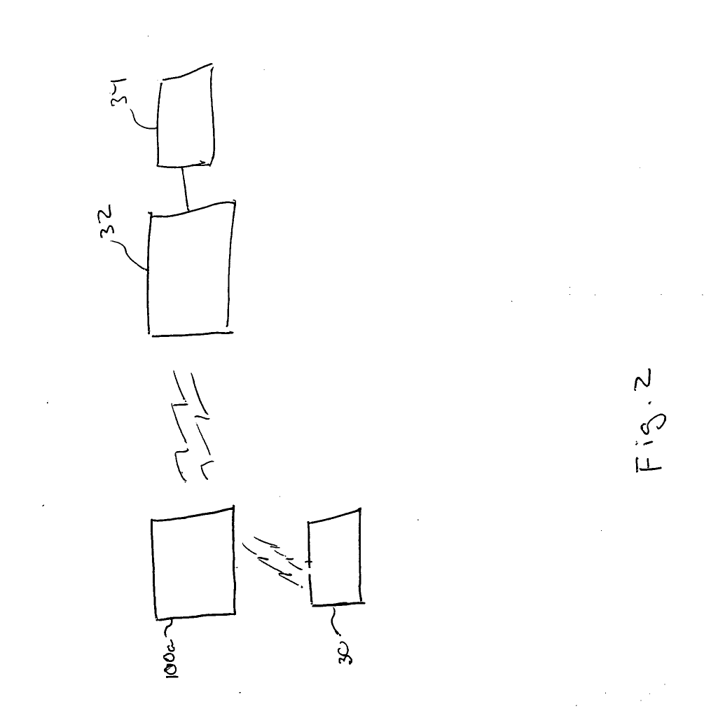

FIG. 2 illustrates a further embodiment of the present invention, whereby the on board unit 100a detects a specific passenger on the basis of a passenger specific identification device 30. The passenger specific identification device 30 can be, for example, a transponder, a magnetic card reader, a key pad in which the passenger enters an individualized identification number, etc. On the basis of the passenger specific identification device 30, the data stream that is provided to the stationary part 32 associates the passenger with the data stream. Thus, the particular recording is readily associated with the specific passenger. In addition thereto, the stationary part 32, the POS terminal 21, a network database 34, etc., can associate and group a plurality of data streams from different rides and associate them with each specific passenger. Thus, the passenger may later retrieve from, for example, the internet a culmination of videos or a selected portion thereof from each of the rides that they were on.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A video recording device for amusement rides comprising:
at least one camera aimed at a passenger during the amusement ride;
an on-board unit for processing and storing the recorded signals;
a transmitting antenna;
an energy storage device,
a receiving antenna; and
a receiving unit,
wherein the at least one camera, the on-board unit, the transmitting antenna, and the energy storage device are provided on a passenger carrier.

2. The video recording device according to claim 1, wherein the passenger carrier further comprises at least one microphone.

3. The video recording device according to claim 2, wherein the at least one camera and the at least one microphone are provided in a common housing.

4. The video recording device according to claim 1, wherein the on-board unit is controlled by a control unit, which is provided on the passenger carrier.

5. The video recording device according to claim 1, further comprising at least one stationary data storage unit and/or at least one point of sale terminal and/or at least one display device.

6. The video recording device according to claim 1, wherein at least one converter is provided for creating a data structure, particularly a DVD image, from the video data and optionally audio data.

7. The video recording device according claim 1, further comprising a writing device for writing the recorded signals to a portable data carrier, a DVD, and/or a video tape.

8. The video recording device according to claim 1, wherein the receiving unit is controlled by a management system.

9. The video recording device according to claim 1, wherein the on-board unit includes an encoder for generating digital data from the received video signals and/or from audio signals.

10. The video recording device according to claim 1, wherein the on-board unit has at least one of the following components as a single unit or multiple units: a data storage unit, a local control unit, a data processing unit, a transmitting unit, an AC line adapter, a camera control unit, and a microphone preamplifier.

11. The video recording device according to claim 10, wherein the data storage unit is a memory and/or a flash memory.

12. The video recording device according to claim 1, wherein a cable that connects the energy storage device to the on-board unit has a connecting plug, in which an address of the on-board unit is encoded.

13. The video recording device according to claim 1, wherein signal transmitters are provided along the ride track, and wherein a control unit is provided for evaluating transmitted signals.

14. A method for creating a video recording of a ride of a passenger on an amusement ride, the method comprising the steps of:
recording video signals with a camera that is placed on the passenger carrier;
generating digital data, particularly in the form of an MPEG-2 stream, in an on-board unit of a passenger carrier from the recorded video signals;
transmitting the digital data via a transmitting unit and an antenna;
receiving the digital data via a stationary antenna and a receiving unit; and
storing the received digital data in a data storage unit.

15. The method according to claim 14, wherein, in addition to video signals, audio signals are also recorded and converted to digital data.

16. The method according to claim 14, wherein the digital data are temporarily stored in the on-board unit.

17. The method according to claim 14, wherein a time-limited presentation loop and/or a photo are created from the digital data and shown to the passenger after the ride.

18. The method according to any claim 14, wherein a data structure and/or a DVD image is created from the digital data and written to a portable data carrier and/or a DVD.

19. The method according to claim 17, wherein the digital data, the presentation loop, and/or the photo are stored in an external storage medium for viewing, for retrieval, and/or for ordering by a Web browser.

20. The method according to claim 14, wherein, based on signals, which are transmitted by signal transmitters along the ride track, one or more of the following functions are performed:
initiating the recording of the digital data;
initiating the recording of the digital data for a set period;
labeling of the beginning of the presentation loop;
ending the recording of the digital data;
transmitting the digital data;
turning the transmitting unit on or off; or
switching between a normal and an infrared recording.

21. The video recording device according to claim 1, wherein the receiving antenna and/or the receiving unit are stationary.

22. An apparatus comprising:
a video camera for recording a passenger on an amusement park ride, the video camera being provided on a passenger carrier of the amusement park ride;
an identification device for identifying a specific passenger; and
a transmitting device for transmitting recorded video signals from the video camera to a processing unit,
wherein the recorded video signals are associated with the specific passenger on the basis of the identification of the specific passenger.

23. The apparatus according to claim 22, wherein a plurality of video signals from a plurality of amusement park rides are associated with the specific passenger.

24. The apparatus according to claim 22, wherein the identification device is a transponder or a magnetic card.
